(19) United States
(12) Patent Application Publication
(10) Pub. No.: US 2017/0204636 A1
(43) Pub. Date: Jul. 20, 2017

(54) Lock Assembly Including Threaded Drive Assembly and Related Methods

(71) Applicant: UNIKEY TECHNOLOGIES INC., Orlando, FL (US)

(72) Inventor: Todd J. Sack, Dover, DE (US)

(21) Appl. No.: 15/402,084

(22) Filed: Jan. 9, 2017

Related U.S. Application Data
(60) Provisional application No. 62/280,369, filed on Jan. 19, 2016.

(51) Int. Cl. E05B 47/00; G07C 9/00; E05C 1/08

(52) U.S. Cl. CPC E05B 47/0012; E05C 1/08; G07C 9/00182; E05B 2047/002; E05B 2047/0017; E05B 2047/0048; E05B 2047/0095

(57) ABSTRACT

A lock assembly may include a gear motor and a worm drive assembly. The worm drive assembly may include a first worm drive segment coupled to the gear motor and that includes a first threaded body, an unthreaded extension body extending outwardly from the first threaded body, and a pin extending radially outward at a distal end of the unthreaded extension body. A second worm drive segment may include a second threaded body having a bore therethrough rotatably mounted on the unthreaded extension body. The second threaded body may have a notch at a distal end thereof receiving the pin. A lead bolt may have a threaded bore therein receiving the first and second threaded bodies. The pin may cooperate with the notch to misalign the first and second threaded bodies to prevent forced positioning from the extended position to the retracted position.

### TECHNICAL FIELD

The present disclosure is directed to the field of locks, and more particularly, to lock assemblies that include a lead bolt and related methods.

### BACKGROUND

Protecting or securing access to an area may be particularly desirable. For example, it is often desirable to secure a home or business. One way of securing access to an area is with a mechanical lock. A mechanical lock typically accepts a key, which may move a deadbolt or enable a door handle to be operated.

A deadbolt, for example, is a locking mechanism that generally can be moved between extended and retracted positions by way of rotation of a lock cylinder, for example, with a key. Thus, a deadbolt may provide increased security, for example, relative to a spring lock.

U.S. Pat. No. 4,395,063 to Bianco discloses a self-interlocking deadbolt assembly. More particularly, Bianco discloses a self-interlocking dead bolt assembly for the door on a safe depository or like security container that includes a dead bolt guide mounted on the inner face of the door and a bore that extends end-to-end through the dead bolt guide to permit an elongated dead bolt of high strength steel to be slidably mounted in the bore and movable to extend beyond the dead bolt guide for engagement with a strike or keeper to lock the door when it is in the closed position.

U.S. Pat. No. 1,472,782 to Barber is directed to a shaft coupling. The shaft-coupling includes exterior and interior oppositely winding helical springs, centrally bored and interiorly and exteriorly threaded bushings for receiving and having frictional engagement solely with the convolutions at the end of said helices, wherein the central bore is adapted to receive shafting, and means for preventing relative rotative movement between the shafting and bushings when the same are assembled.

Additionally, it may be desirable to increase user convenience with respect to a mechanical lock, such as, for example, a deadbolt. A passive keyless entry (PKE) system may provide an increased level of convenience over a standard lock and key, for example, by providing the ability to access a secure area without having to find, insert, and turn a traditional key. For example, a user may access a secure area using a remote access device, such as, for example, a FOB or mobile wireless communications device. In a PKE system, access may be provided to the secure area without pressing a button or providing other input to the remote device, thus making it passive.

U.S. Patent Application Publication No. 2014/0340196 to Myers et al. discloses an access control system via direct and indirect communications. More particularly, Myers et al. discloses a lock assembly communicating with a mobile device and a gateway to communicate with the lock. Operating commands such as lock and unlock are communicated directly from the mobile device or indirectly after confirming, for example, using GPS coordinates of the mobile device.

U.S. Patent Application Publication No. 2012/0280790 to Gerhardt et al. is directed to a system for controlling a locking mechanism using a portable electronic device. More particularly, Gerhardt et al. discloses using a web service to authenticate a portable electronic device, detecting the proximity of the portable electronic device to the lock, and issuing a command for receipt by the lock from the web service or portable electronic device.

U.S. Patent Application No. 2006/0164208 to Schaffzin et al. is directed to a universal hands free key and lock system. A universal key that transmits an ID to a lock unit. The lock unit has a range limited reader. The lock unit detects the transmitted ID and based thereon operates the lock.

### SUMMARY

A lock assembly to be carried by a door may include a gear motor and a worm drive assembly. The worm drive assembly may include a first worm drive segment coupled to the gear motor. The first worm drive segment may include a first threaded body, an unthreaded extension body extending outwardly from the first threaded body, and a pin extending radially outward at a distal end of the unthreaded extension body. The worm drive assembly may also include a second worm drive segment that includes a second threaded body having a bore therethrough rotatably mounted on the unthreaded extension body. The second threaded body may have a notch at a distal end thereof receiving the pin. A lead bolt may have a threaded bore therein receiving the first and second threaded bodies so that rotation of the first worm drive segment in a first rotational direction extends the lead bolt from a retracted position to an extended position, and rotation of the first worm drive segment in a second rotational direction retracts the lead bolt from the extended position to the retracted position. The pin may cooperate with the notch to misalign the first and second threaded bodies to prevent forced positioning of the lead bolt from the extended position to the retracted position. Accordingly, the lock assembly may prevent a force from “back-driving” a fully extended lead bolt to its retracted position.

The lock assembly may include a lock controller coupled to the gear motor and configured to operate the gear motor based upon a remote access wireless device, for example. The lock assembly may also include lock wireless communications circuitry coupled to the lock controller. The lock assembly may further include interior and exterior facing directional antennas coupled to the lock wireless communications circuitry.

The first and second worm drive segments may have a cylindrical shape. The threaded bore has a helically shaped thread, for example. The first and second threaded bodies each may have a helically shaped thread.

The lock assembly may also include a clutch coupled to the gear motor and the worm drive assembly. The lock assembly may further include a touch sensor coupled to the lock controller. The controller may be configured to operate the gear motor based upon the touch sensor, for example. The lock assembly may also include a housing carrying the gear motor, worm drive assembly, and the lead bolt.

A method aspect is directed to a method of making a lock assembly. The method may include coupling a first worm drive segment of a worm drive assembly to a gear motor. The first worm drive segment includes a first threaded body, an unthreaded extension body extending outwardly from the first threaded body, and a pin extending radially outward at a distal end of the unthreaded extension body. The method may also include rotatably mounting a second worm drive segment of the worm drive assembly and comprising a second threaded body having a bore therethrough on the unthreaded extension body. The second threaded body has a notch at a distal end there of receiving the pin. The method may also include coupling a lead bolt having a threaded bore therein to receive the first and second threaded bodies so that rotation of the first worm drive segment in a first rotational direction extends the lead bolt from a retracted position to an extended position, and rotation of the first worm drive segment in a second rotational direction retracts the lead bolt from the extended position to the retracted position. The pin cooperates with the notch to misalign the first and second threaded bodies to prevent forced positioning of the lead bolt from the extended position to the retracted position.

### BRIEF DESCRIPTION OF THE DRAWINGS

FIG. 1 is a cross-sectional view of a lock assembly in accordance with an embodiment.

FIG. 2a is a perspective view of aligned first and second worm drive segments of FIG. 1.

FIG. 2b is a perspective view of misaligned first and second worm drive segments of FIG. 1.

FIG. 3 is a diagram illustrating a side schematic view of a lock assembly of a wireless access control system and a remote access device of the wireless access control system carried by a user in accordance with an embodiment.

FIG. 4 is a schematic block diagram of the wireless access control system of FIG. 1.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

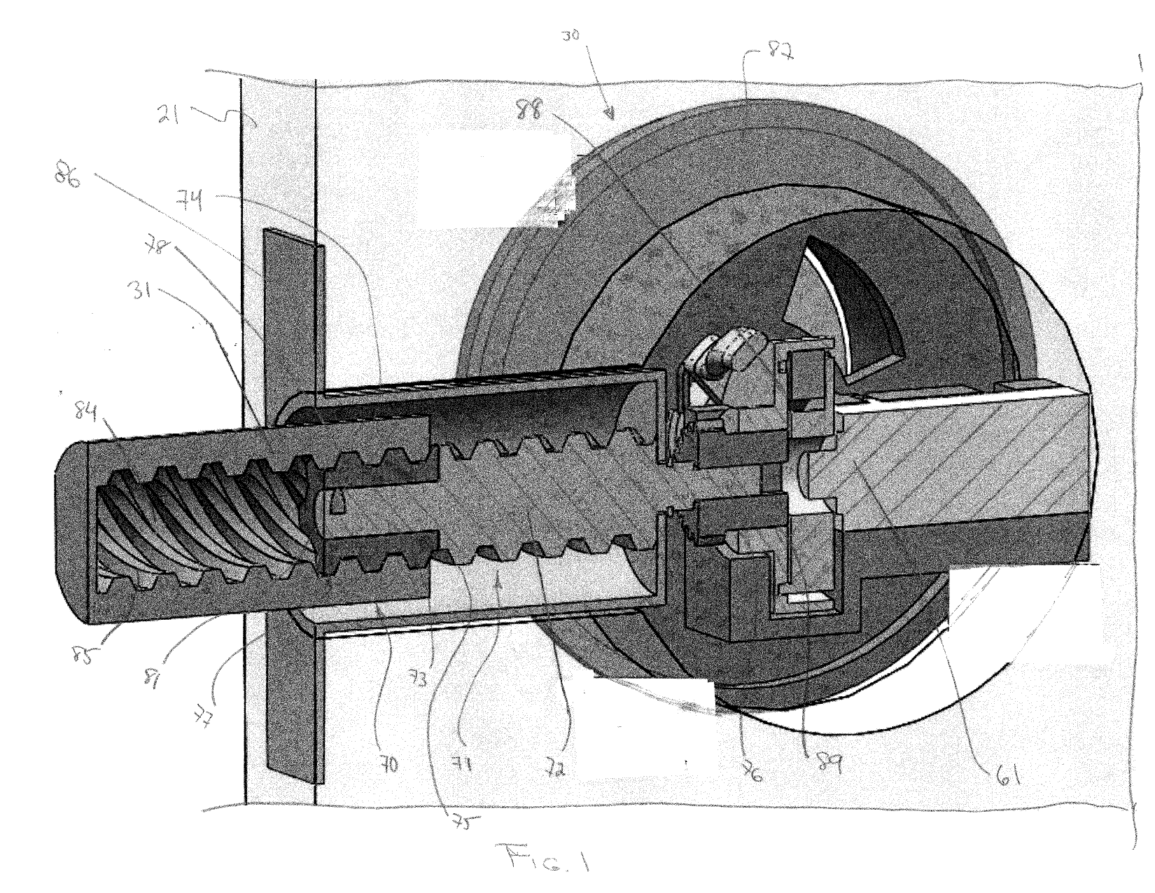

Referring initially to FIG. 1, a lock assembly 30 is carried by a door 21. The door 21 may be an interior door, exterior door, overhead garage door, a door to a structure, overhead door, sliding door, screen door, revolving door, for example, a home or business, or any other door that separates an area where protection of that area may be desirable.

The lock assembly 30 illustratively is in the form of a deadbolt lock and includes a lead bolt 31. The lead bolt 31 is switchable between extended (FIG. 1) and retracted positions.

The lock assembly 30 also illustratively includes a gear motor 61 and a worm drive assembly 70 coupled to the gear motor. A clutch 88 and gears 89 are between the gear motor 61 and the worm drive assembly 70. A housing 87 carries the gear motor 61, the clutch 88, the gears 89, the worm drive assembly 70, and the lead bolt 31. The housing 87 may carry other and/or additional components, as will be appreciated by those skilled in the art.

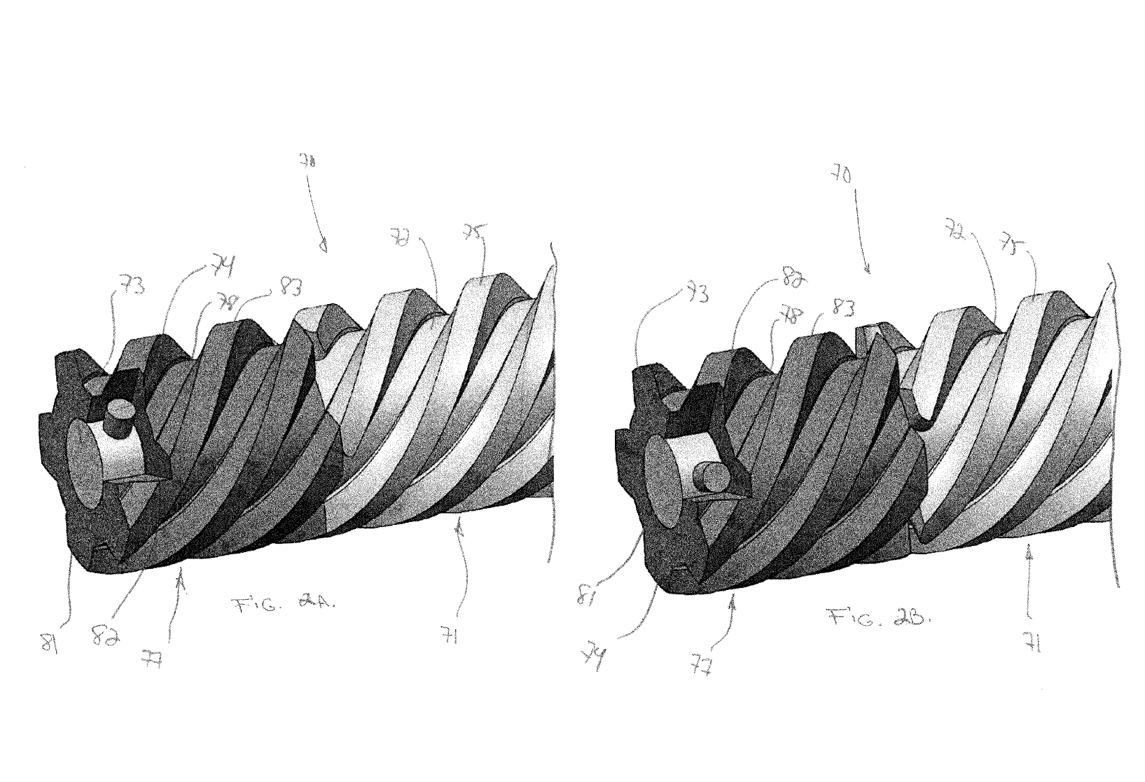

Referring additionally to FIGS. 2a and 2b, the worm drive assembly 70 illustratively includes a first worm drive segment 71 coupled to the gear motor 61. The first worm drive segment 71 includes a first threaded body 72, an unthreaded extension body 73 extending outwardly from the first threaded body, and a pin 74 extending radially outward at a distal end of the unthreaded extension body. The first threaded body 72 illustratively has a cylindrical shape, and the thread 75 illustratively has a helical shape. The thread 75 may be considered a “male” thread. A post 76 extends at a proximal end to couple with the gear motor 61.

The worm drive assembly 70 also has a second worm drive segment 77 that includes a second threaded body 78 having a bore 81 therethrough rotatably mounted on the unthreaded extension body 73. The second threaded body 78 has a notch 82 at a distal end thereof receiving the pin 74. The second threaded body 78 also illustratively has a cylindrical shape, and the thread 83 is illustratively in a helical shape to correspond to the thread 75 of the first threaded body 72. The thread 83 of the second threaded body 78 may also be considered a “male” thread. The first and second threaded bodies 72, 78 may be collectively considered a “lead screw” as will be appreciated by those skilled in the art.

The lead bolt 31 illustratively has a threaded bore 84 therein receiving the first and second threaded bodies 72, 78. The lead bolt 31 has a rounded-rectangular exterior shape, similar to a conventional deadbolt, and the threaded bore 84 has a cylindrical shape corresponding to the shape of the first and second threaded bodies 72, 78. The thread 85 within the threaded bore 84 also has a helical shape and corresponds with or cooperates with the threads 75, 83 of the first and second threaded bodies 72, 78. In other words, the thread 85 within the threaded bore 84 may be considered a “female” thread. The threaded bore 84 receives the first and second threaded bodies 72, 78 so that rotation of the first worm drive segment 71 in a first rotational direction extends the lead bolt 31 from a retracted position to an extended position, and rotation of the first worm drive segment in a second rotational direction retracts the lead bolt from the extended position to the retracted position.

The pin 74 also cooperates with the notch 82 to misalign the first and second threaded bodies 72, 78 to prevent forced positioning from the extended position to the retracted position. The worm drive assembly 70 remains in a fixed position and the hollow or bored lead bolt 31 moves laterally to and from extended and retracted positions. When the lead bolt 31 is in the retracted position, the threaded bore 84 “encloses” the entire worm drive assembly 70. Of course, in other embodiments, the threaded bore may not “enclose” the entire worm drive assembly 70. As the worm drive assembly 70 rotates, the worm drive assembly effectively applies a lateral force on the lead bolt 31, which has the resultant effect of retracting or extending the lead bolt.

The worm drive assembly 70 does not move laterally with the lead bolt 31, but instead, the worm drive assembly rotates about its axis while staying approximately in the same spatial position. The worm drive assembly 70 can move the lead bolt 31 laterally in a first direction (e.g., laterally outward) by rotating the worm drive assembly in a first direction (e.g., clockwise looking at the lock assembly's faceplate 86 “head on”), and can move the lead bolt in the opposite direction (i.e., laterally inward) by rotating the worm drive assembly in a second direction (i.e., counterclockwise looking at the faceplate) opposite to the first direction. For the lead bolt 31 to extend or retract, the thread 83 of the second threaded body 78 must be “aligned” with the thread 75 of the first threaded body 72. Upon alignment, the first and second threaded bodies 72, 78 are aligned to define a continuous thread. In contrast, when the first and second threaded bodies 72, 78 are misaligned, by way of the free rotation of the second worm drive segment 77 caused by the notch 82, the lead bolt 31 is prevented from being “back-driven” after being fully extended, as will be described in further detail below.

The “back driving” prevention is achieved by misaligning the first and second threaded bodies 72, 78. The aligned first and second threaded bodies 72, 78 first move the lead bolt 31 into a fully extended position. When the lead bolt 31 is fully extended, the second threaded body 78 is able to rotate freely around the unthreaded body extension 73 for a distance corresponding to the size of the notch 82. In other words, when the lead bolt 31 is moved to the fully extended position, the first threaded body 72 is no longer inside the threaded bore 84 of the lead bolt, and only the second threaded body 78 is inside threaded bore. Accordingly, the second threaded body 78 may be fully or partially enclosed by the threaded bore 84. When the lead bolt 31 is moved to the fully extended position, the first threaded body 72 continues to rotate such that the pin 74 moves within the notch 82 so that the first and second threaded bodies 72, 78 move from being “aligned” (FIG. 2a) to being “misaligned” (FIG. 2b). Since the first threaded body 72 is no longer inside of the threaded bore 84, the first worm drive segment 71 may be considered “free” to rotate, however, as noted above, the first worm drive segment will only rotate freely (without rotating the second worm drive segment 72) for a distance corresponding to the size of the notch 82. In other words, the rotation of the first worm drive segment 71 relative to the second worm drive segment 77 stops when the pin 74 physically contacts the second threaded body 78 in the notch 82.

Once the lead bolt 31 is fully extended and the first and second threaded bodies 72, 78 are misaligned, if, for example, an attacker tries to retract the lead bolt 31 with brute force by physically pushing the lead bolt back to its retracted position, the lead bolt might retract a small amount, but will ultimately remain securely extended. With a brute force back-driving push attack, the lead bolt 31 may retract slightly to the point where the second worm drive segment 77 is completely encompassed in the threaded bore 84. However at this point, further retraction motion is prevented because the threads 75, 83 of the first and second threaded bodies 72, 78, respectively, are misaligned.

From the extended position, upon rotation in a direction opposite that to extend the lead bolt 31, the first and second threaded bodies 72, 78 re-align and subsequently retract the lead bolt. For example, if the first and second threaded bodies 72, 78 are misaligned, the first worm drive segment first rotates counterclockwise (looking at the faceplate 86; for example, approximately 36°), at which point the pin 74 contacts and applies pressure to the second threaded body in the notch 82. The force applied by the pin 74 rotates both the first and second worm drive segments 71, 77, the first and second threaded bodies 72, 78 of which have become aligned, thus retracting the lead bolt 31.

As will be appreciated by those skilled in the art, the lock assembly 30 may be particularly advantageous to prevent against forced retraction of the lead bolt 31. However, the lock assembly, similar other types of locks, may be subject to other types of attacks, for example, a vertically downward strike with a hammer or other impacting tool, especially since the lead bolt 31 includes the threaded bore 84. Thus, it may be particularly desirable for the lead bolt 31 to be a relatively strong metal, for example, steel, alloy or other material with increased resistance to breaking. It may also be desirable that the first and second worm drive segments also be of a material having increased strength, for example, to reduce the likelihood of stripping of the threads 75, 83. Additionally, the lock assembly 30 may provide increased space savings as the space inside the lead bolt 31, which is typically solid, may be used to create a relatively smaller lock form factor.

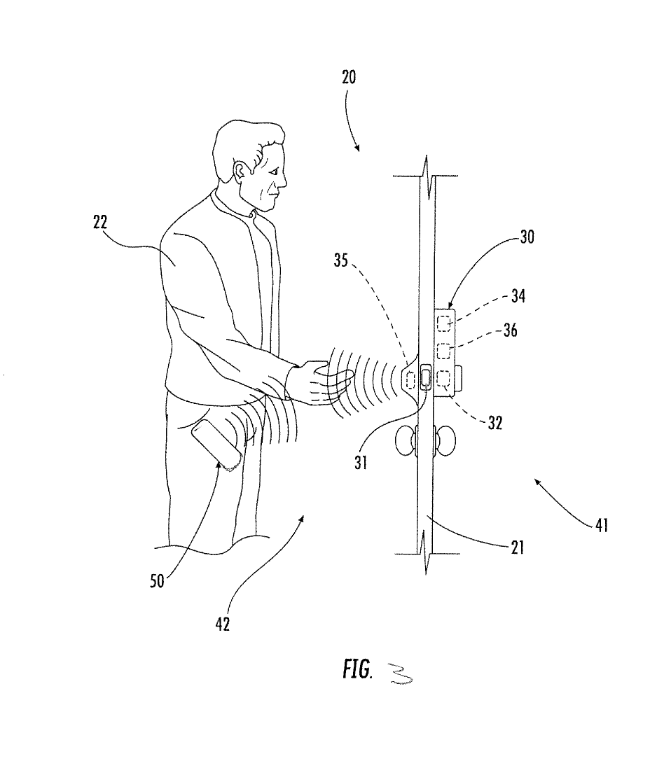

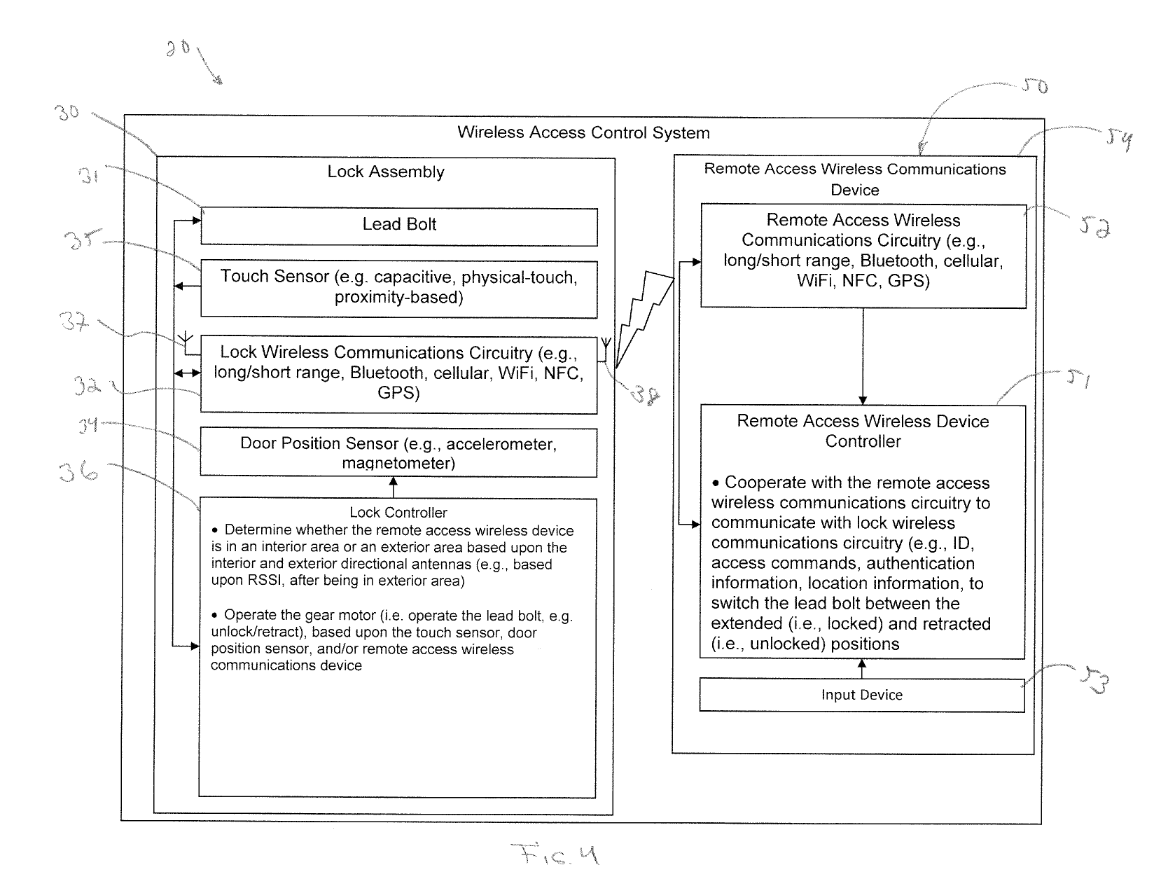

Referring additionally to FIGS. 3 and 4, the lock assembly 30 may be particularly useful for use in a wireless access control system 20 in which case the lock assembly 30 may be considered a smart lock and includes lock wireless communications circuitry 32. The lock assembly 30 is illustratively exposed on both the interior and exterior of the door 21. It should be understood that the term interior may refer to the side of the door 21 that faces an area desirable of protection or secured space. For example, where the lock assembly 30 is carried by a door of a home, the interior side 41 is the side within the home, while the exterior side 42 is outside the home and may be accessible to people other than the home's inhabitants.

The lock wireless communications circuitry 32 may be configured to communicate via one or more short range wireless communications protocols, for example, Bluetooth, NFC, WLAN, or other communications protocols. The lock wireless communications circuitry 32 may also communicate via a long range communication protocol, for example, cellular, or global positioning system, or other long range communication protocol. The lock wireless communications circuitry 32 may communicate using either or both of one or more short and long range protocols, as will be appreciated by those skilled in the art.

The lock assembly 30 also includes interior and exterior directional antennas 37, 38 coupled to the lock wireless communications circuitry 32. The interior and exterior directional antennas are pointed or directed to interior and exterior areas 41, 42 respectively.

The lock assembly 30 also illustratively includes a door position sensor 34. The door position sensor 34 may include an accelerometer, for example. The door position sensor 34 may also include a magnetometer. In some embodiments, the door position sensor 34 may include both an accelerometer and a magnetometer, or other and/or additional devices, sensors, or circuitry configured to sense a position of the door 21. For example, the door position sensor 34 may determine when the door 21 has been opened and/or closed, moved, stationary, etc. A pattern of movement of the door 21 can be determined, for example, opened and then closed, closed then opened, based upon the door position sensor 34.

The lock assembly 30 also illustratively includes a touch sensor 35 on the exterior of the lock assembly 30 to sense touching by a user 22. The touch sensor 35 may be a capacitive touch sensor, for example, and when the lead bolt 31 includes a key hole, may be positioned around the key hole. The touch sensor 35 may be positioned elsewhere on the lock assembly 30. More than one touch sensor 35 may be used. For example, in some embodiments, the lock assembly 30 may include an interior touch sensor and an exterior touch sensor. Other types of touch sensors may also be used. For example, the touch sensor 35 may not necessarily sense touching directly from a user, but rather touching using an intervening object that may be an extension of the user. The lead bolt 31 may be switched between the locked and unlocked positions based upon the touch sensor 35. For example, the user 22 may lock the door 21 by touching the touch sensor 35.

The touch sensor 35 may be a physical-touch sensor for sensing physical contact with the user, for example. The touch sensor 35 may alternatively or additionally be a proximity-based touch sensor configured to sense proximity of the user thereto. In other words, while a touch sensor 35 is described herein, the touch sensor senses either a physical touch of the user or when the user is in a relatively close proximity to the touch sensor, for example, a small distance from the lock assembly 30 (e.g., less than 12 inches), such as by an access card reader, a FOB reader, or other circuitry to sense a user within a relatively small distance from the lock assembly 30 or door 21.

The wireless access control system 20 also illustratively includes a remote access device 50 remote from the lock assembly 30. The remote access device 50 includes a remote access device controller 51 and remote access wireless communications circuitry 52 coupled to the remote access device controller 51. The remote access device controller 51 and the remote access device wireless communications circuitry 52 cooperate to communicate with the lock wireless communications circuitry 32. For example, the remote access device controller 51 and the remote access device wireless communications circuitry 52 cooperate to communicate access commands, location information, authentication information, and/or other information for communicating with and controlling operation of the lead bolt 31, and/or other devices that may be included in the wireless access control system 20, as will be appreciated by those skilled in the art. The remote access device controller 51 may also communicate with the lock wireless communications circuitry 32 for switching said lock between the locked and unlocked positions. Similar to the lock wireless communication circuitry 32, the remote access device wireless communications circuitry 52 may communicate using one or both of short range and long range communications protocols.

The remote access device 50 may be in the form of a fob or keychain, and may include a housing 54 carrying a battery for powering the remote access device controller 51 and wireless communications circuitry 52, and at least one input device 53 carried by the housing and coupled to the remote access device controller 51. In other embodiments, the remote access device 50 may be a cellular telephone, tablet PC, or any other portable wireless communications device. The lock assembly 30 further includes a lock controller 36 coupled to gear motor 61, the lock wireless communications circuitry 32, the door position sensor 34, and the touch sensor 35.

The gear motor 61 is coupled to the lock controller 36 and operates based thereupon. For example, the lock controller 36 may operate the gear motor 61 upon the touch sensor and user authorization as described above, which causes the lead bolt 31 to retract from the locked position. Of course, the lock controller 36 may operate the gear motor 61 based upon other factors and/or so that the lead bolt 31 extends and/or retracts.

The lock controller 36 is configured to operate the gear motor 61 to retract the lead bolt 31 based upon the touch sensor 35 to permit a user 22 to open the door 21. More particularly, the lock controller 36 may switch the lead bolt 31 to the unlocked position based upon the user 22 touching the touch sensor 35.

As will be appreciated by those skilled in the art, during a typical touch-to-unlock operation based upon the touch sensor 35, the lock controller 36 may “wake-up” from a low power mode and begin scanning for an advertising remote access wireless communications device 50. The lock controller 36 may, thereafter, connect with an in-range remote access wireless communications device 50 and determine the identity of the in-range remote access wireless communications device. If the remote access wireless communications device 50 is authorized to access the lock, the lock controller 36 may cooperate with the lock wireless communications circuitry 32 and based upon the interior and exterior directional antennas 37, 38 determine whether the remote access wireless communications device is in the interior area 41 or the exterior area 42. If the user 22 is authorized to access the lock, e.g. at that time, and the remote access wireless communications device is determined to be in the exterior area 42, the lock controller 36 may switch the lock before returning to the low-power mode. It should be noted that it generally takes about 1 to 2 seconds from the time the user 22 touches the touch sensor 35 until the lead bolt 31 is switched or retracted.

A method aspect is directed to a method of making a lock assembly 30. The method includes coupling a first worm drive segment 71 of a worm drive assembly 70 to a gear motor 61. The first worm drive segment 71 includes a first threaded body 72, an unthreaded extension body 73 extending outwardly from the first threaded body, and a pin 74 extending radially outward at a distal end of the unthreaded extension body. The method also includes rotatably mounting a second worm drive segment 77 of the worm drive assembly 70, which includes a second threaded body 78 having a bore 81 therethrough, on the unthreaded extension body 73. The second threaded body 78 has a notch 82 at a distal end there of receiving the pin 74. The method also includes coupling a lead bolt 31 having a threaded bore 84 therein to receive the first and second threaded bodies 72, 78 so that rotation of the first worm drive segment 71 in a first rotational direction extends the lead bolt 31 from a retracted position to an extended position, and rotation of the first worm drive segment in a second rotational direction retracts the lead bolt from the extended position to the retracted position. The pin 74 cooperates with the notch to misalign the first and second threaded bodies 72, 78 to prevent forced positioning of the lead bolt 31 from the extended position to the retracted position.

While the lock assembly 30 has been described with respect to a wireless access control system, it should be noted that the lock assembly may be used in a system that is not based upon wireless access or a remote access wireless device. In other words, the lock assembly 30 may be used as a stand-alone lock assembly. Moreover, while a specific embodiment of the lock assembly 30 has been described herein, it will be appreciated that different arrangements of the worm drive assembly 70 may be used. For example, the unthreaded extension body 73′ may have the notch 82′ therein, and the pin 74′ may extend radially inward from the bore 81′ of the second worm drive segment 77′. This arrangement also permits cooperation of the pin 74′ and the notch 82′ to misalign the first and second threaded bodies 72′, 78′ to prevent forced positioning of the lead bolt 31′ from the extended position to the retraced position.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A lock assembly to be carried by a door and comprising:
a gear motor;
a worm drive assembly comprising
a first worm drive segment coupled to said gear motor and comprising a first threaded body, an unthreaded extension body extending outwardly from said first threaded body, and a pin extending radially outward at a distal end of said unthreaded extension body, and
a second worm drive segment comprising a second threaded body having a bore therethrough rotatably mounted on the unthreaded extension body, the second threaded body having a notch at a distal end thereof receiving said pin; and
a lead bolt having a threaded bore therein receiving said first and second threaded bodies so that rotation of said first worm drive segment in a first rotational direction extends said lead bolt from a retracted position to an extended position, and rotation of said first worm drive segment in a second rotational direction retracts said lead bolt from the extended position to the retracted position;
said pin cooperating with the notch to misalign said first and second threaded bodies to prevent forced positioning of the lead bolt from the extended position to the retracted position.

2. The lock assembly of claim 1 further comprising a lock controller coupled to said gear motor and configured to operate said gear motor based upon a remote access wireless device.

3. The lock assembly of claim 2 further comprising lock wireless communications circuitry coupled to said lock controller.

4. The lock assembly of claim 2 further comprising interior and exterior facing directional antennas coupled to said lock wireless communications circuitry.

5. The lock assembly of claim 1 wherein said first and second worm drive segments have a cylindrical shape.

6. The lock assembly of claim 1 wherein the threaded bore has a helically shaped thread.

7. The lock assembly of claim 1 wherein said first and second threaded bodies each have a helically shaped thread.

8. The lock assembly of claim 1 further comprising a clutch coupled to said gear motor and said worm drive assembly.

9. The lock assembly of claim 1 further comprising a touch sensor coupled to said lock controller; and wherein said controller is configured to operate said gear motor based upon said touch sensor.

10. The lock assembly of claim 1 further comprising a housing carrying said gear motor, worm drive assembly, and said lead bolt.

11. A method of making lock assembly to be carried by a door and comprising:
coupling a first worm drive segment of a worm drive assembly to a gear motor, the first worm drive segment comprising a first threaded body, an unthreaded extension body extending outwardly from the first threaded body, and a pin extending radially outward at a distal end of the unthreaded extension body;
rotatably mounting a second worm drive segment comprising a second threaded body having a bore therethrough on the unthreaded extension body, the second threaded body having a notch at a distal end thereof receiving the pin; and
positioning a lead bolt having a threaded bore therein to receive the first and second threaded bodies so that rotation of the first worm drive segment in a first rotational direction extends the lead bolt from a retracted position to an extended position, and rotation of the first worm drive segment in a second rotational direction retracts the lead bolt from the extended position to the retracted position;
the pin cooperating with the notch to misalign the first and second threaded bodies to prevent forced positioning of the lead bolt from the extended position to the retracted position.
